(19) United States
(12) Patent Application Publication
(10) Pub. No.: US 2010/0281414 A1
(43) Pub. Date: Nov. 4, 2010

(54) METHODS AND SYSTEMS FOR TRAVEL PLANNING

(76) Inventors: Dana L. Ventura, Ewing, NJ (US); Matthew J. Ventura, Ewing, NJ (US)

Correspondence Address: Marcy M. Hoefling, 1474 Hood Ave., Baton Rouge, LA, 70808, US

(21) Appl. No.: 12/772,966

(22) Filed: May 3, 2010

Related U.S. Application Data
(60) Provisional application No. 61/175,420, filed on May 4, 2009.

(51) Int. Cl. G06F 3/048

(52) U.S. Cl. 715/771

(57) ABSTRACT

Travel planning methods and systems are provided that allow a traveler to specify at least a travel origin, a travel duration, and travel destination criteria, and receive two or more travel options that satisfy the specified origin, duration, and destination criteria, and that provide the real-time cost associated with each of the travel options, wherein at least one of the travel options is to a different destination than another of the travel options.

This application claims priority to U.S. Provisional Patent Application No. 61/175,420 filed May 4, 2009.

### BACKGROUND

On-line travel agent systems such as those provided at internet web sites TRAVELOCITY.COM, KAYAK.COM, and EXPEDIA.COM, generally require input into a relatively structured query before information such as available flight times, available lodging locations, and costs associated with that query are provided. In particular, input of both a starting city or airport and a destination city or airport, are required. There is limited flexibility, e.g., the user can opt to include travel from and/or to airports in the vicinity of the starting and/or destination locations.

Current systems require a user to execute numerous, repetitive searches to research costs for travel to different destinations, and require the user to specify the destination in each instance. Current systems work well for users who want to specify a single destination airport and possibly opt for airports in the vicinity of the destination airport. Current systems also offer what they deem “multi city” searches which allow users to plan travel to a first destination, continuing on to a second destination, etc., and eventually ending in their city of origin (for example travelling from city “A” to city “B”, then from city “B” to city “C”, and then from city “C” back to city “A”). Thus, current systems are very limiting because, while potential travelers usually are willing to specify a starting airport given that they usually begin travel from a home location, they frequently have in mind only knowledge of the dates when they want to travel, or of how much time they can devote to a vacation (e.g., time off from work) and a general date range during which they want to travel, but do not particularly want to specify a single destination, or any destination at all. Such travelers would like to know the different travel options that are available to them for the available time and are interested in receiving information about travel to different destinations. They may also have in mind an activity they would like to participate in, and maybe also how much money they can spend on the travel. Some sites are offering to provide results of searches that were performed by others in the past. With current systems, even if the user takes the time to research travel to multiple destinations, the user will miss out on gaining knowledge about travel options and current cost information for the available dates/money for any destination not specifically researched.

Thus, there is a need for on-line travel agent systems and methods that enable a user to receive multiple travel options with current cost information based on input starting location, and number of days available for travel, and offers other flexibilities.

### THE INVENTION

This invention meets the above-described needs by providing methods and systems that allow users to search flights from their city of origin to multiple first destinations. This invention provides methods that comprise, in regard to travel, receiving input from a user into a computer-implemented system, wherein the input comprises information about at least (i) a travel origin comprising an origin city or an origin airport (ii) travel duration criteria comprising a specified departure date and specified return date for the travel, or a general date range and a number of days available for the travel, and (iii) travel destination criteria comprising a destination region, a destination activity, two or more destination cities, or two or more destination airports; and obtaining real-time data from one or more information sources based on the input received from the user; and formulating from the real-time data and providing to the user in real time, output about two or more travel options, wherein each of the travel options comprises information about at least (i) a departing flight that originates on an actual departure date from a starting airport in, or in the vicinity of, the travel origin and that arrives at an actual destination, (ii) a return flight from a return airport in, or in the vicinity of, the actual destination on an actual return date and that arrives in, or in the vicinity of, the travel origin, and (iii) real-time cost of the travel option, wherein: (a) either each of the actual departure dates is on the specified departure date and each of the actual return dates is on the specified return date, or each of the actual departure dates is within the general date range and each of the actual return dates follows the actual departure date by the number of days available for travel, and the actual destination is in the destination region, or is, or is in the vicinity of, at least one of the destination cities or destination airports, or the destination activity is available at or in the vicinity of the actual destination, and (b) the actual destination of at least one of the travel options is different than the actual destination of another of the travel options. Also provided are such methods wherein the input also comprises a maximum amount of money available for the travel; and wherein the real-time cost of each of the travel options is no more than about the maximum amount of money available for the travel; and wherein the specified departure date and/or the specified return date and/or the number of days available for travel has a designated flexibility; and wherein each of the travel options also comprises information about lodging available at the actual destination from a date that the departing flight arrives at the actual destination through the actual return date; and wherein each of the travel options also comprises information about a rental vehicle available at the actual destination from a date that the departing flight arrives at the actual destination through the actual return date; and wherein the computer-implemented system is adapted to provide queries to assist the user in inputting the travel destination criteria and the user provides answers to the queries.

The invention also provides computer-implemented systems that are adapted to receive input from a user, wherein the input comprises information about at least (i) a travel origin comprising an origin city or an origin airport (ii) travel duration criteria comprising a specified departure date and specified return date for the travel, or a general date range and a number of days available for the travel, and (iii) travel destination criteria comprising a destination region, a destination activity, two or more destination cities, or two or more destination airports; and obtain real-time data from one or more information sources based on the input received from the user; and formulate from the real-time data and provide to the user in real time, output about two or more travel options, wherein each of the travel options comprises information about at least (i) a departing flight that originates on an actual departure date from a starting airport in, or in the vicinity of, the travel origin and that arrives at an actual destination, (ii) a return flight from a return airport in, or in the vicinity of, the actual destination on an actual return date and that arrives in, or in the vicinity of, the travel origin, and (iii) real-time cost of the travel option, wherein: (a) either each of the actual departure dates is on the specified departure date and each of the actual return dates is on the specified return date, or each of the actual departure dates is within the general date range and each of the actual return dates follows the actual departure date by the number of days available for travel, and the actual destination is in the destination region, or is, or is in the vicinity of, at least one of the destination cities or destination airports, or the destination activity is available at or in the vicinity of the actual destination, and (b) the actual destination of at least one of the travel options is different than the actual destination of another of the travel options. Also provided are such systems wherein the input also comprises a maximum amount of money available for the travel; and wherein the real-time cost of each of the travel options is no more than about the maximum amount of money available for the travel; and wherein the specified departure date and/or the specified return date and/or the number of days available for travel has a designated flexibility; and wherein each of the travel options also comprises information about lodging available at the actual destination from a date that the departing flight arrives at the actual destination through the actual return date; and wherein each of the travel options also comprises information about a rental vehicle available at the actual destination from a date that the departing flight arrives at the actual destination through the actual return date; and wherein the system is adapted to provide queries to assist the user in inputting travel destination criteria. In systems and methods of this invention, a user is not limited to either specifying/selecting a destination region or a destination activity, a user may opt to specify/select each, or even two or more of each for obtaining more results from which to select. Also encompassed within this invention are computer-implemented systems that provide queries to the user to which the user can provide input, which input is used by the system to provide travel options suitable for the user. Further, systems and methods of this invention can be adapted, by means known to those skilled in the art, to allow the user to book reservations based on the travel options provided.

Methods and systems of this invention are advantageous because they enable potential travelers to efficiently search travel to multiple destinations from their origin city in one search. To our knowledge, no currently available search systems offer this advantage.

### BRIEF DESCRIPTION OF THE DRAWINGS

The accompanying drawing illustrates the invention and together with the description serves to explain the principles of the invention:

FIG. 1 illustrates an example interface for use in implementing an embodiment of this invention

### INPUT

### Travel Origin

Systems of this invention can receive a “travel origin”, e.g., an origin city or airport, e.g., via a user entering same into a computer-implemented system. The travel origin is where the travel will originate. Typically, the origin city or airport is where or near where the user resides. Optionally, in what is deemed having a “designated flexibility”, the origin city can include cities within a designated distance from a designated location, i.e., from where the user resides, and/or the origin airport can include airports within a designated distance from a designated location, i.e., from a selected airport. For example, the origin city can include a designated city and any city within 50 miles of the designated city. Or, for example, the origin airport can include a designated airport and any airport within 50 miles of the designated airport.

### Travel Duration Criteria

### Specified Departure Date and Specified Return Date

A specified departure date and specified return date can be utilized by methods and systems of this invention to designate the dates upon which the user wants to travel. Optionally, in what is deemed having a “designated flexibility”, the specified departure date and/or specified return date can include dates within a designated number of days on either side of a date entered by the user. For example, the user can opt to enter a specified departure date of Oct. 15, 2011, plus or minus 5 days, such that the specified departure date would include any date from Oct. 10, 2011, through Oct. 15, 2011.

### General Date Range and Number of Days Available for Travel

A general date range and a number of days available for travel can be utilized by methods and systems of this invention to designate when the user wants to travel. For example, the user may know that she wants to travel anytime from Jun. 1, 2011, through Aug. 15, 2011, and knows that she has 14 days available for the travel. Also included in this invention are methods and systems wherein a user can indicate a willingness to see travel results that are for travel of shorter or longer periods of time than the number of days available for travel if such travel results give a total cost that is less expensive than travel results that are for the number of days available for travel. Optionally, the user can specify how much less expensive the total cost must be before such travel results are shown to the user. That is, the number of days available for travel can have a designated flexibility.

Other flexibilities are known to those skilled in the art, or will be known based on the disclosure provided herein. All such other flexibilities are encompassed within the scope of this invention.

### Travel Destination Criteria

### Destination Region

Methods and systems of this invention can utilize a destination region that can be specified by the user or selected from regions provided by the system. Regions can be organized in many different ways. One example is to have the following regions from which a user may select: Europe, United States, South America, Africa, or Asia. If desired, the user can select a region that encompasses anywhere on the earth to which airlines fly. Another example is Southern United States, Eastern United States, Western United States, Northern United States, Eastern Europe, Western Europe, etc. Other organizations of regions are known to those skilled in the art, or will be known based on the disclosure provided herein. All such other organizations are encompassed within the scope of this invention.

### Destination Activity

Methods and systems of this invention can utilize a destination activity that can be specified by the user or selected from activities provided by the system. Example destination activities include, without limitation, skiing, surfing, scuba diving, snorkeling, or hiking. Methods and systems of this invention will provide output comprising information about travel options to actual destinations at which the destination activity is available or from which the destination activity is accessible.

### Travel Destination Queries

Also anticipated by this invention are methods and systems that provide queries about the users personal likes and dislikes to help define the travel destination criteria.

### Destination Cities or Airports

Methods and systems of this invention can utilize two or more destination cities or two or more destination airports that can be specified by the user.

### Optional Input—Maximum Amount of Money to be Spent for Travel

Optionally, systems of this invention can receive a maximum amount of money to be spent for travel. The user can be instructed to base this amount on only available departing and return airline flights if no lodging estimate is requested, or to base this amount on available departing and return airline flights and lodging. Optionally, if other estimates are requested by the user, such as costs for multiple travelers, the user can be instructed to base this amount on the number of travelers. Also included in this invention are methods and systems wherein a user can indicate a willingness to see travel results that are for travel options that have a total cost that exceeds the maximum amount of money to be spent for travel by a specified amount or percentage. That is, the maximum amount of money to be spent can have a designated flexibility. Other flexibilities are anticipated by this invention.

### Other Optional Inputs

Optionally, systems and methods of this invention can receive and utilize a value that represents the number of travelers. Costs can be based on the total number of travelers.

Optionally, systems and methods of this invention can receive and utilize other inputs, for example, without limitation, inputs such as one or more specified airline, whether only direct flights are sought, whether particular types of lodging are required, whether a rental vehicle is sought, and the like. Other such optional inputs are known to those skilled in the art, or will be known based on the disclosure provided herein. All such optional inputs are encompassed within the scope of this invention.

### Real-Time Data Based on the Input

In methods and systems of this invention, real-time data is obtained from one or more information sources based on the input received from the user. Suitable information sources include various electronic information sources that are available via electronic means, e.g., via the internet or database servers, for providing real-time data. These information sources include those for which usage fees must be paid. Such suitable information sources and how to obtain information from them are known to those skilled in the art. For example, use of global distribution system (GDS) databases, which would be suitable for use in this invention, are familiar to those skilled in the art. As used herein, “real-time data” means data that is the most current data available from the information source(s) accessed by the system of this invention at the time that the input from a system of this invention is received. To clarify, real-time data is different from data that is compiled from previous searches and saved for future access. Also, “real-time cost” as used herein means the cost that is the most current data available from the information source(s) accessed by the system of this invention at the time that the input from a system of this invention is received.

Methods and systems of this invention are adapted to formulate from the real-time data and provide to the user in real time, output about two or more travel options. Formulation of output from the real-time data can be accomplished by one or more software-implemented algorithms, as will be familiar to those skilled in the art. Any number and variety of such software-implemented algorithms are either currently existing or can be developed, as is familiar to those skilled in the art. As used herein, providing output in real time means that output is provided to the user reasonably soon after it is formulated according to this invention. To clarify, providing output in real time is different from providing output that has been compiled for one or more previous users.

### Output

### Travel Options

Methods and systems of this invention provide output to a user about two or more travel options, at least two of which are for travel to differing destinations. For example, if twenty travel options are provided, and nineteen are for travel to an actual destination of Boston, the other travel option will be for travel to an actual destination other than Boston, e.g., it may be for travel to an actual destination of Miami. The number of travel options and the number of different actual destinations encompassed therein will be dependent upon the input of the user.

### Departing Flight

Each travel option provided will comprise information about a departing flight that originates on an actual departure date from a starting airport in, or in the vicinity of, the travel origin and that arrives at an actual destination. What is meant by “departing flight” is a plan of one direct flight or a series of two or more connecting flights that will transport a traveler from the starting airport to the actual destination. What is meant by “actual destination” is a city or airport. The departing flight will land at an airport; if the actual destination is a city, including a city within a specified destination region, the departing flight will land at an airport within, or in the vicinity of, that city. What is meant by “in the vicinity of” can be defined by the system as, e.g., within 50 miles of or within 60 miles of. Alternatively, the system can allow the user to specify the distance that is meant by “in the vicinity of”.

### Return Flight

Each travel option provided will comprise information about a return flight from a return airport in, or in the vicinity of, the actual destination on an actual return date and that arrives in, or in the vicinity of, the travel origin. What is meant by “return flight” is a plan of one direct flight or a series of two or more connecting flights that will transport a traveler from the return airport to the travel origin. If the travel origin is a city, it is clear that the return flight will land at an airport within, or in the vicinity of, the travel origin.

### Cost of the Travel Option

Each travel option provided will comprise the real-time cost of the travel option. The real-time cost will include at least the cost of the airfare, and can include the cost of other options entered/selected by the user.

### Output Requirements

For the output provided, either (i) each of the actual departure dates will be on the specified departure date and each of the actual return dates will be on the specified return date, or (ii) each of the actual departure dates will be within the general date range and each of the actual return dates will follow the actual departure date by the number of days available for travel. Also, for each travel option provided, either (i) the actual destination will be in the destination region, or will be, or will be in the vicinity of, at least one of the destination cities or destination airports, or (ii) the destination activity will be available at or in the vicinity of the actual destination. What is meant by “in the vicinity of” can be defined by the system as, e.g., within 50 miles of or within 60 miles of. Alternatively, the system can allow the user to specify the distance that is meant by “in the vicinity of”.

For the output provided, the actual destination of at least one of the travel options will be different than the actual destination of another of the travel options. This means that at a minimum, if one of the travel options provides departing flight information from the starting airport to airport “A”, at least one of the other travel options will provide departing flight information from the starting airport to an airport that is not airport “A”. For example, if the user has specified for the travel destination criteria the destination cities of Newark, N.J., and Philadelphia Pa., at least one of the travel options must comprise information about a departing flight that arrives at Newark, N.J., and at least one of the travel options must comprise information about a departing flight that arrives at Philadelphia Pa.

Information about other user-specified features can also be provided.

### Organization of the Output

The output of the system can be a list of actual destinations sorted by price. The output can be organized in any number of ways and can include many types of useful information, as will be known to one skilled in the art given the disclosure provided herein. All such ways of organizing are within the scope of this invention.

### System Interface

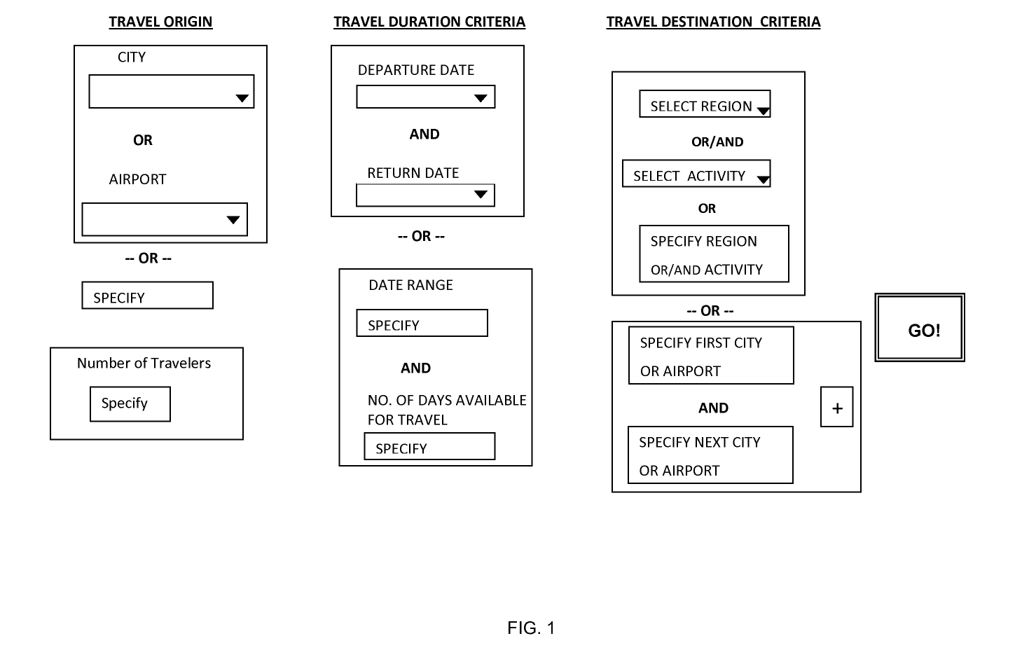

FIG. 1 shows an example interface that can be used in implementing this invention. FIG. 1 illustrates that a user can be prompted to enter input into a computer-implemented system about a travel origin, which can be a city or an airport, and can be selected from a dropdown box or specified. For the travel duration criteria, this interface prompts for entry of a departure date and a return date. Alternatively, a date range and a number of days available for travel can be specified. This interface allows entry of travel destination criteria. A region or/and activity can be selected from a dropdown box or by specifying. Alternatively two or more destination cities or airports can be specified. Multiple destinations can be specified by selecting the addition button “+”, which adds additional boxes for the user to enter specified destinations. This interface also prompts for the number of travelers. Once input is complete, the user selects “GO!” in order to obtain output from a system according to this invention.

There are numerous additional interface means via which methods and systems of this invention can be implemented. For example, software can be devised by which a user could go to a map site, such as mapquest.com or maps.google.com, input information such as described herein, and for example, select a city, state or country, or scan over the map to obtain real-time costs for flights etc. On such a site, organizations at the actual destination, e.g., hotels, restaurants, museums, theaters, and other tourist attractions, could pay to have information about the organization pop up.

Systems of this invention can be programmed to send updates to the user once an itinerary is selected. Numerous other features can be included, as will be familiar to those skilled in the art.

### EXAMPLES

The following examples are illustrative of the principles of this invention. It is understood that this invention is not limited to any one specific embodiment exemplified herein, whether in the examples or the remainder of this patent application.

### Example 1

### Region Search

In reply to the following input prompts, a user provides the input replies shown.

Input prompt: Please enter the origin city you would like to depart from;
Input reply: Newark, N.J.
Input prompt: Please enter the distance from the origin city you would be willing to depart from (from 0 to 150 miles);
Input reply: 0 miles.
Input prompt: Please enter the date range you would like to travel;
Input reply: Apr. 20, 2011-Jun. 20, 2011.
Input prompt: Please enter the number of days available for travel;
Input reply: 15.
Input prompt: Please enter the desired region, specified multiple destinations, or activity;
Input reply: Region: Europe

The following output is provided to the user, sorted from lowest to highest cost.

1. $400: Paris, France—departs Newark May 15, 2011—Return May 30, 2011.
2. $435: Madrid, Spain—departs Newark May 20, 2011—Return Jun. 4, 2011.
3. $800: Milan, Italy—departs Newark May 28, 2011—Return Jun. 12, 2011.

### Example 2

### Activity Search

In reply to the following input prompts, a user provides the input replies shown.

Input prompt: Please enter the origin city you would like to depart from;
Input reply: Newark, N.J.
Input prompt: Please enter the distance from the origin city you would be willing to depart from (from 0 to 150 miles);
Input reply: 75 miles.
Input prompt: Please enter the date range you would like to travel;
Input reply: Feb. 1, 2011—Mar. 15, 2011.
Input prompt: Please enter the number of days available for travel;
Input reply: 10 days.
Input prompt: Please enter a desired region, specified multiple destinations, or activity;
Input reply: skiing

The following output is provided to the user, sorted from lowest to highest cost.

1. $200: Denver, Colo.—departs Newark Feb. 1, 2011—Return Feb. 11, 2011.
2. $275: Denver, Colo.—departs LaGuardia Feb. 6, 2011—Return Feb. 16, 2011.
3. $290: Reno, Nev.—departs Newark Mar. 1, 2011—Return Mar. 11, 2011.

### Example 3

### Specified Multiple Destination Search

In reply to the following input prompts, a user provides the input replies shown.

Input prompt: Please enter the origin city you would like to depart from;
Input reply: Newark, N.J.
Input prompt: Please enter the distance from the origin city you would be willing to depart from (from 0 to 150 miles);
Input reply: 75 miles
Input prompt: Please enter the desired Departure Date;
Input reply: May 15, 2011.
Input prompt: Please enter the desired Return Date;
Input reply: May 25, 2011.
Input prompt: Please enter a desired region, specified multiple destinations, or activity;
Input reply: Miami, Fla.
San Francisco, Calif.
Cancun, Mexico
San Juan, Puerto Rico

The following output is provided to the user, sorted from lowest to highest cost.

1. $200: Miami, Fla.—departs Newark May 15, 2011—Return May 25, 2011.
2. $275: San Francisco—departs LaGuardia May 15, 2011—Return May 25, 2011.
3. $375: San Francisco—departs LaGuardia May 15, 2011—Return May 25, 2011.
4. $450: Cancun, Mexico—departs Newark May 15, 2011—Return May 25, 2011.
5. $475: San Juan, Puerto Rico—departs LaGuardia May 15, 2011—Return May 25, 2011.

### Example 4

### System Destination Queries

In this example, a system of this invention is adapted to provide queries to the user and to utilize the answers/input provided by the user to provide the user with travel options that are suitable for the user based on the answers/input.

Input prompt: Please select the origin city you would like to depart from;
Input selection: New Orleans, La.
Input prompt: Please enter the distance from the origin city you would be willing to depart from (from 0 to 150 miles);
Input reply: 0.
Input prompt: Please enter the date range you would like to travel;
Input reply: Jun. 1, 2011—Aug. 1, 2011.
Input prompt: Please enter the number of days available for travel;
Input reply: 8.
Input prompt: Would you like system assistance in defining your destination choices?;
Input choices: yes/no
Input reply: yes
Input prompt: Please select a region from the following list: {The list provided includes: Caribbean, Europe, Southern United States, Northern United States, Eastern United States, Western United States, South America, Asia, Africa.};
Input reply: selection of Caribbean
Input prompt: Okay, please select an activity from the following list: {The list provided includes: swimming, hiking, snorkeling, scuba diving, skiing, shopping.}
Input reply: hiking

In this example, the list of activities that is provided to the user is based on the user's selection of the region of Caribbean.

The following output is provided to the user, sorted from lowest to highest cost.

1. $450: St. Kitts—departs New Orleans Jun. 15, 2011—Return Jun. 23, 2011.
2. $800: St. Lucia—departs New Orleans Jun. 20, 2011—Return Jun. 28, 2011.
3. $1200: Dominica—departs New Orleans Aug. 20, 2011—Return Aug. 28, 2011.

While the present invention has been described in terms of one or more preferred embodiments, it is to be understood that other modifications may be made without departing from the scope of the invention, which is set forth in the claims below.

What is claimed is:

1. A method comprising:
in regard to travel, receiving input from a user into a computer-implemented system, wherein the input comprises information about at least (i) a travel origin comprising an origin city or an origin airport, (ii) travel duration criteria comprising a specified departure date and specified return date for the travel, or a general date range and a number of days available for the travel, and (iii) travel destination criteria comprising a destination region, a destination activity, two or more destination cities, or two or more destination airports; and
obtaining real-time data from one or more information sources based on the input received from the user; and
formulating from the real-time data and providing to the user in real time, output about two or more travel options, wherein each of the travel options comprises information about at least (i) a departing flight that originates on an actual departure date from a starting airport in, or in the vicinity of, the travel origin and that arrives at an actual destination, (ii) a return flight from a return airport in, or in the vicinity of, the actual destination on an actual return date and that arrives in, or in the vicinity of, the travel origin, and (iii) real-time cost of the travel option, wherein:
(a) either each of the actual departure dates is on the specified departure date and each of the actual return dates is on the specified return date, or each of the actual departure dates is within the general date range and each of the actual return dates follows the actual departure date by the number of days available for travel, and
the actual destination is in the destination region, or is, or is in the vicinity of, at least one of the destination cities or destination airports, or
the destination activity is available at or in the vicinity of the actual destination, and
(b) the actual destination of at least one of the travel options is different than the actual destination of another of the travel options.

2. The method of claim 1 wherein the input also comprises a maximum amount of money available for the travel.

3. The method of claim 2 wherein the real-time cost of each of the travel options is no more than about the maximum amount of money available for the travel.

4. The method of claim 1 wherein the specified departure date and/or the specified return date and/or the number of days available for travel has a designated flexibility.

5. The method of claim 1 wherein each of the travel options also comprises information about lodging available at the actual destination from a date that the departing flight arrives at the actual destination through the actual return date.

6. The method of claim 1 wherein each of the travel options also comprises information about a rental vehicle available at the actual destination from a date that the departing flight arrives at the actual destination through the actual return date.

7. The method of claim 1, wherein the computer-implemented system is adapted to provide queries to assist the user in inputting the travel destination criteria and the user provides answers to the queries.

8. A computer-implemented system that is adapted to:
receive input from a user, wherein the input comprises information about at least (i) a travel origin comprising an origin city or an origin airport (ii) travel duration criteria comprising a specified departure date and specified return date for the travel, or a general date range and a number of days available for the travel, and (iii) travel destination criteria comprising a destination region, a destination activity, two or more destination cities, or two or more destination airports; and
obtain real-time data from one or more information sources based on the input received from the user; and
formulate from the real-time data and provide to the user in real time, output about two or more travel options, wherein each of the travel options comprises information about at least (i) a departing flight that originates on an actual departure date from a starting airport in, or in the vicinity of, the travel origin and that arrives at an actual destination, (ii) a return flight from a return airport in, or in the vicinity of, the actual destination on an actual return date and that arrives in, or in the vicinity of, the travel origin, and (iii) real-time cost of the travel option, wherein:
(a) either each of the actual departure dates is on the specified departure date and each of the actual return dates is on the specified return date, or each of the actual departure dates is within the general date range and each of the actual return dates follows the actual departure date by the number of days available for travel, and
the actual destination is in the destination region, or is, or is in the vicinity of, at least one of the destination cities or destination airports, or
the destination activity is available at or in the vicinity of the actual destination, and
(b) the actual destination of at least one of the travel options is different than the actual destination of another of the travel options.

9. The system of claim 8 wherein the input also comprises a maximum amount of money available for the travel.

10. The system of claim 9 wherein the real-time cost of each of the travel options is no more than about the maximum amount of money available for the travel.

11. The system of claim 8 wherein the specified departure date and/or the specified return date and/or the number of days available for travel has a designated flexibility.

12. The system of claim 8 wherein each of the travel options also comprises information about lodging available at the actual destination from a date that the departing flight arrives at the actual destination through the actual return date.

13. The system of claim 8 wherein each of the travel options also comprises information about a rental vehicle available at the actual destination from a date that the departing flight arrives at the actual destination through the actual return date.

14. The system of claim 8, wherein the system is adapted to provide queries to assist the user in inputting travel destination criteria.

15. A method comprising:
in regard to travel, receiving input from a user into a computer-implemented system, wherein the input comprises information about at least (i) a travel origin, (ii) travel duration criteria, and (iii) travel destination criteria; and
obtaining real-time data from one or more information sources based on the input received from the user; and
formulating from the real-time data and providing to the user in real time, output about two or more round-trip flights, each of which originates at an airport in or in the vicinity of the travel origin and at least one of which travels from the airport to a different destination than at least one of the others, wherein
the output includes at least the dates and real-time costs of each round-trip flight.
